(19) United States
(12) Patent Application Publication
(10) Pub. No.: US 2018/0013853 A1
(43) Pub. Date: Jan. 11, 2018

(54) INFORMATION PROCESSING DEVICE, INFORMATION PROCESSING SYSTEM, NON-TRANSITORY COMPUTER-READABLE STORAGE MEDIUM, AND INFORMATION PROCESSING METHOD

(71) Applicant: FUJITSU LIMITED, Kawasaki-shi (JP)

(72) Inventors: Eiichi Takahashi, Kawasaki (JP); Junichi Yura, Kawasaki (JP); Hiroyasu Sugano, Koto (JP); AKIRA SHIBA, Kawasaki (JP); Tatsuro Matsumoto, Yokohama (JP)

(73) Assignee: FUJITSU LIMITED, Kawasaki-shi (JP)

(21) Appl. No.: 15/611,263

(22) Filed: Jun. 1, 2017

(30) Foreign Application Priority Data
Jul. 11, 2016 (JP) 2016-137036

(51) Int. Cl. H04L 29/08; H04W 4/00

(52) U.S. Cl. CPC H04L 67/2847; H04L 67/1097; H04W 4/008

(57) ABSTRACT

An information processing device includes: a memory; and a processor coupled to the memory and configured to execute first transmission processing that includes transmitting a processing request that corresponds to an operation of a user to a server device coupled to the information processing device through a network, in accordance with the operation by the user, execute storage processing that includes storing a processing request that corresponds to an operation executed when communication with the server device is not allowed to be performed, and execute second transmission processing that includes transmitting the processing request stored during the storage processing, to a further information processing device allowed to transmit a processing request that corresponds to an operation by the user to the server device.

### CROSS-REFERENCE TO RELATED APPLICATION

This application is based upon and claims the benefit of priority of the prior Japanese Patent Application No. 2016-137036, filed on Jul. 11, 2016, the entire contents of which are incorporated herein by reference.

### FIELD

The embodiments discussed herein are related to an information processing device, an information processing system, a non-transitory computer-readable storage medium, and an information processing method.

### BACKGROUND

In the related art, a client/server model mobile application has been prevalent. Such a mobile application operates on a terminal such as a smartphone, and provides a service using user information and business information managed on the side of a server (cloud) to a user of the terminal. When the user inputs an operation to utilize the service to the terminal, the mobile application sequentially transmits a processing request that corresponds to the operation to the server.

Recently, such a mobile application is allowed to continue to operate even when the terminal is in the offline state so that a processing request that corresponds to an operation that has been performed during the offline state is stored, using an application cache function and a local storage function of HTML5. As a result, the user may continue to use the application even in a situation in which the terminal is not allowed to be coupled to the server through a network. Japanese Laid-open Patent Publication No. 2006-350444 is the related art.

### SUMMARY

According to an aspect of the invention, an information processing device includes: a memory; and a processor coupled to the memory and configured to execute first transmission processing that includes transmitting a processing request that corresponds to an operation of a user to a server device coupled to the information processing device through a network, in accordance with the operation by the user, execute storage processing that includes storing a processing request that corresponds to an operation executed when communication with the server device is not allowed to be performed, and execute second transmission processing that includes transmitting the processing request stored during the storage processing, to a further information processing device allowed to transmit a processing request that corresponds to an operation by the user to the server device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a configuration example of an information processing system according to a first embodiment;

FIG. 2 is a diagram illustrating a hardware configuration example of an information terminal according to the embodiment;

FIG. 3 is a diagram illustrating an example of function blocks of the information terminal and a server device;

FIG. 4 is a sequence diagram illustrating an example of processing of the information processing system according to the first embodiment;

FIG. 5 is a diagram illustrating an example of application information;

FIG. 6 is a sequence diagram illustrating an example of proxy determination processing;

FIG. 7 is a sequence diagram illustrating an example of authentication processing at the time of the proxy execution;

FIGS. 8A and 8B are a sequence diagram illustrating an example of processing in which authentication has not been performed successfully;

FIG. 9 is a diagram illustrating encrypted application information;

FIGS. 10A and 10B are diagrams each illustrating a case in which a proxy operation is requested for a plurality of information terminals;

FIG. 11A is a flowchart illustrating an example of processing executed by an information terminal that is a proxy request source;

FIG. 11B is a flowchart illustrating an example of processing executed by an information terminal that is a proxy request destination;

FIG. 12 is a flowchart illustrating an example of processing executed by the server device;

FIG. 13 is a diagram illustrating an example of service information;

FIG. 14 is a diagram illustrating a configuration example of an information processing system according to a second embodiment;

FIG. 15 is a sequence diagram illustrating an example of processing of an information processing system according to a third embodiment; and

FIG. 16 is a sequence diagram illustrating an example of processing of an information processing system according to a fourth embodiment.

### DESCRIPTION OF EMBODIMENTS

In the related art, it is desirable that a processing request stored during the offline state is transmitted to the server at some future time. Therefore, it is desirable for the user to couple the terminal to the server again.

Here, an object of an embodiment is to allow a terminal to transmit a processing request for a server, to the server, even in a state in which it is difficult for the terminal to communicate with the server.

Embodiments of the technology discussed herein are described below with reference to drawings.

### First Embodiment

<System Configuration>

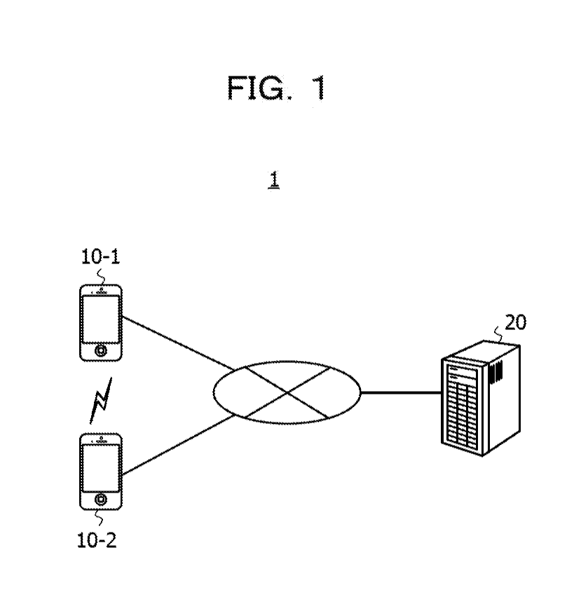

FIG. 1 is a diagram illustrating a configuration example of an information processing system according to a first embodiment. In FIG. 1, an information processing system 1 includes a plurality of information terminals 10-1, 10-2, . . . (hereinafter simply referred to as “information terminal 10” when the information terminals are not distinguished from one another) and a server device 20.

The information terminal 10 and the server device 20 are coupled to each other through a wireless local area network (LAN) or a communication line such as a LAN so as to be allowed to communicate with each other. In addition, the information terminals 10 are allowed to communicate with each other, for example, through short-range wireless communication or the like.

The information terminal 10 is, for example, a smartphone, a tablet-type terminal, a personal computer (PC), or the like.

To the information terminal 10, an application (hereinafter, referred to as an app) is distributed from the server device 20. Such an application sequentially transmits a processing request that corresponds to an operation or the like by the user to the server device 20. The app may be, for example, a web app that is written in HTML5 and operates on a web browser.

The server device 20 distributes the app to the information terminal 10, and executes processing that corresponds to a processing request of the app when the server device 20 receives the processing request from the information terminal 10. For example, the server device 20 may be installed in a company office or at school premises and communication with the server device 20 is not allowed to be performed from an external network such as the Internet in order to ensure security.

<Hardware Configuration>

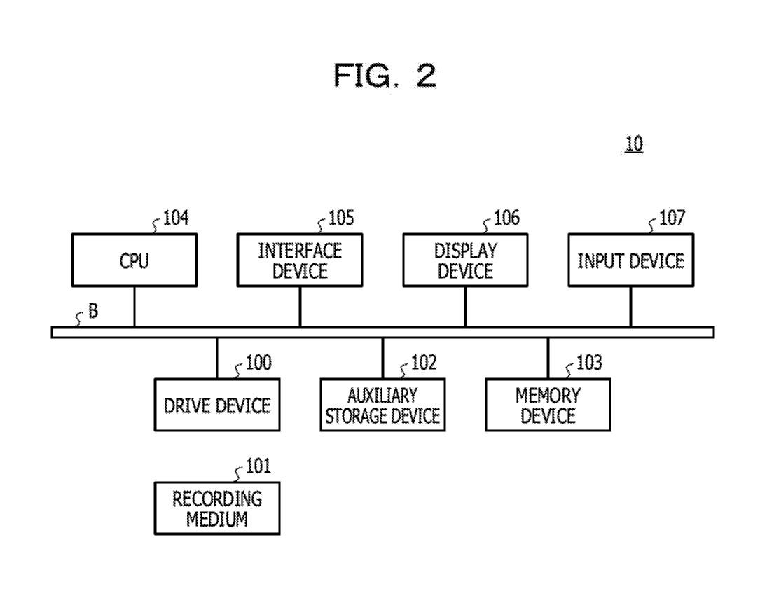

FIG. 2 is a diagram illustrating a hardware configuration example of the information terminal 10 according to the embodiment. The information terminal 10 of FIG. 2 includes a drive device 100, an auxiliary storage device 102, a memory device 103, a central processing unit (CPU) 104, and an interface device 105 that are coupled to each other through a bus B.

An information processing program that performs processing in the information terminal 10 is provided through a recording medium 101. When the recording medium 101 in which the information processing program has been recorded is set to the drive device 100, the information processing program is installed in the auxiliary storage device 102 from the recording medium 101 through the drive device 100. However, the installation of the information processing program may not be performed through the recording medium 101, and the information processing program may be downloaded from a further computer through a network. The auxiliary storage device 102 stores a desired file, data, and the like, in addition to the installed information processing program. When a start instruction of the program has been issued, the memory device 103 reads the program from the auxiliary storage device 102 and stores the program. The CPU 104 performs a function related to the information terminal 10 in accordance with the program stored in the memory device 103. The interface device 105 is used as an interface to couple with the network.

Examples of the recording medium 101 include a portable recording medium such as a compact disc-read-only memory (CD-ROM), a digital versatile disk (DVD), and a universal serial bus (USB) memory. In addition, examples of the auxiliary storage device 102 include a hard disk drive (HDD) and a flash memory. Any one of the recording medium 101 and the auxiliary storage device 102 corresponds to a computer-readable storage medium.

A hardware configuration of the server device 20 may be similar to the hardware configuration example of the information terminal 10 illustrated in FIG. 2.

<Function Configuration>

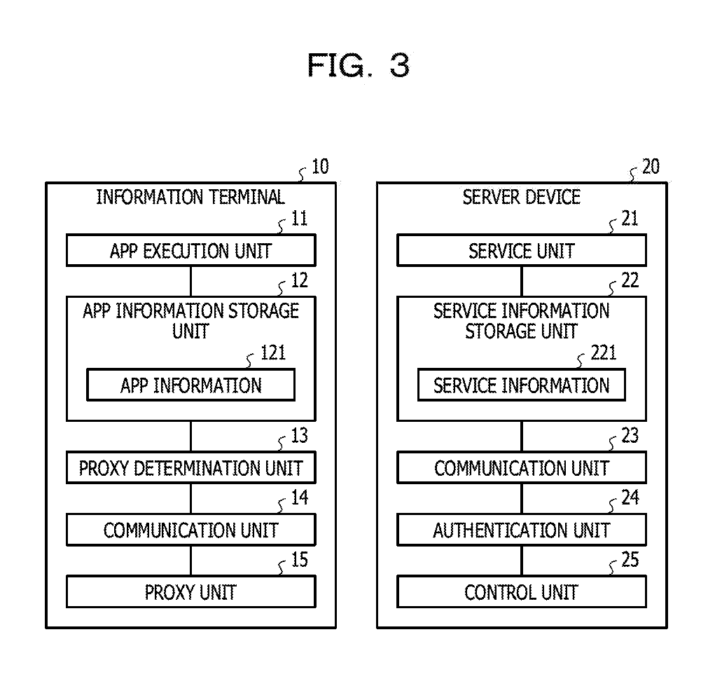

Function configurations of the information terminal 10 and the server device 20 are described below with reference to FIG. 3. FIG. 3 is a diagram illustrating an example of the function blocks of the information terminal 10 and the server device 20.

The information terminal 10 includes an app execution unit 11, a proxy determination unit 13, a communication unit 14, and a proxy unit 15. Each of the units is realized by processing that one or more programs installed in the information terminal 10 cause the CPU 104 of the information terminal 10 to execute.

In addition, the information terminal 10 also includes an app information storage unit 12. The app information storage unit 12 is obtained, for example, by using the auxiliary storage device 102 or the like.

The app execution unit 11 executes an app and transmits an app processing request to the server device 20 through the communication unit 14 when the communication between the information terminal 10 and the server device 20 is established.

The proxy determination unit 13 authenticates a further information terminal 10 that is a request destination for which the information terminal 10 requests a proxy operation of transmission of a processing request of an app to the server device 20 or a further information terminal 10 that is a request source from which a proxy operation is requested.

The communication unit 14 controls communication with a further information terminal 10 and the server device 20.

The proxy unit 15 executes a proxy operation of transmission of a processing request of an app that has been executed in a further information terminal 10 to the server device 20.

The server device 20 includes a service unit 21, a communication unit 23, an authentication unit 24, and a control unit 25. Each of the units is realized by processing that one or more programs installed in the server device 20 cause a CPU of the server device 20 to execute.

In addition, the server device 20 also includes a service information storage unit 22. The service information storage unit 22 is obtained, for example, by the auxiliary storage device or the like.

The service unit 21 provides a certain service to the user, for example, in cooperation with an app in the information terminal 10. The service unit 21 may be realized by using a known technology.

The communication unit 23 controls communication with the information terminal 10.

The authentication unit 24 authenticates an information terminal 10 that executes a proxy operation of reflection of a processing request of an app that has been executed in a further information terminal 10.

The control unit 25 performs control related to processing in which the proxy operation of the reflection of the processing request of the app that has been executed in the further information terminal 10 is executed.

<Processing>

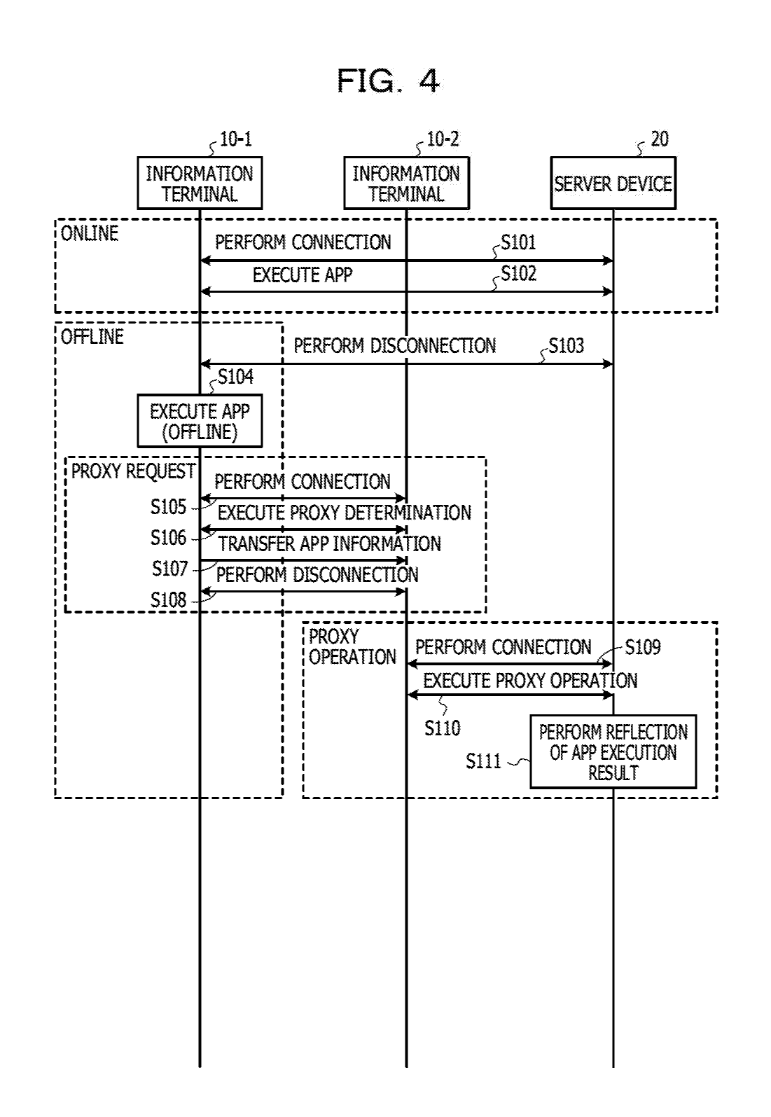

Processing in the information processing system 1 according to the first embodiment is described below with reference to FIG. 4. FIG. 4 is a sequence diagram illustrating an example of the processing in the information processing system 1 according to the first embodiment.

In Step S101, the communication unit 14 of the information terminal 10-1 is coupled to the server device 20 through the network.

Next, for example, the app execution unit 11 of the information terminal 10-1 executes an app in response to an operation by the user and transmits a processing request to the server device 20 (Step S102).

Next, when the information terminal 10-1 enters the offline state in which the information terminal 10-1 is not allowed to communicate with the server device 20 due to movement of the user who is carrying the information terminal 10-1, the communication unit 14 of the information terminal 10-1 detects disconnection from the server device 20 (Step S103).

During the offline state, when the app is executed in response to an operation or the like by the user, the app execution unit 11 of the information terminal 10-1 stores a processing request in the app information storage unit 12 as app information 121 (Step S104).

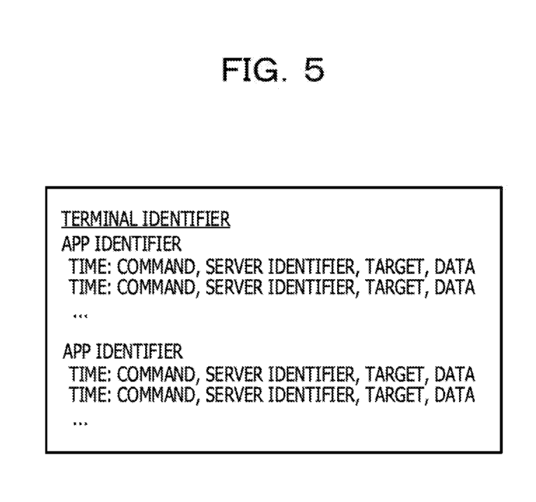

FIG. 5 is a diagram illustrating an example of the app information 121. The app information 121 stores values of items of a terminal identifier, an app identifier for each app, and a time (time stamp), a command, a server identifier, a target, data, and the like for each processing request from each of the apps to the server device 20. When the app is a web app, the app information 121 may be recorded as an HTTP request.

The terminal identifier is information by which the information terminal 10-1 is identified. The app identifier is information by which an executed app is identified. The time is a time at which the processing request has been issued from the app. The command is information indicating a request for the server device 20. For example, there is “registration of data” as an example of the command. The server identifier is information by which the server device 20 that is a transmission destination of the command is identified, and for example, is an IP address of the server device 20. The target is information indicating a resource that is an execution target of the command (for example, a record of a database or the like), and for example, is represented by a universal resource locator (URL). The data is, for example, data registered in the record of the database.

In a case in which the offline state is continued, when the communication unit 14 of the information terminal 10-1 detects the presence of a further information terminal 10-2 in a communication range in which short-range wireless communication with the further information terminal 10-2 is allowed to be performed (entry of the further information terminal 10-2 into the communication range), the communication unit 14 enables communication between the information terminals 10-1 and 10-2 (Step S105). For the communication between the information terminals 10-1 and 10-2, for example, Wi-Fi (registered trademark) Direct, Bluetooth (registered trademark), or the like, may be used.

Next, the proxy determination unit 13 of each of the information terminal 10-1 and the information terminal 10-2 executes proxy determination processing (Step S106). The proxy determination processing is processing in which validity as a request destination of the proxy operation is determined for the information terminal 10-2. Details of the proxy determination processing will be described later.

In the proxy determination processing, when the proxy determination unit 13 determines that the information terminal 10-2 is valid as the request destination of the proxy operation, the communication unit 14 of the information terminal 10-1 transmits the app information 121 stored in the app information storage unit 12 to the information terminal 10-2 (Step S107).

After that, when the communication unit 14 of the information terminal 10-1 detects the absence of the information terminal 10-2 in the short-range wireless communication range of the information terminal 10-1, the communication unit 14 stops the communication between the information terminals 10-1 and 10-2 (Step S108).

Next, the communication unit 14 of the information terminal 10-2 is coupled to the server device 20 through the network at a specific timing (Step S109).

Next, the proxy unit 15 of the information terminal 10-2 executes the proxy operation (Step S110). In the proxy operation, the proxy unit 15 of the information terminal 10-2 transmits the app information 121 that has been received from the information terminal 10-1, to the server device 20.

Next, the service unit 21 of the server device 20 receives the app information 121 of the information terminal 10-1, and executes processing requested in the app information 121 (Step S111).

<Proxy Determination>

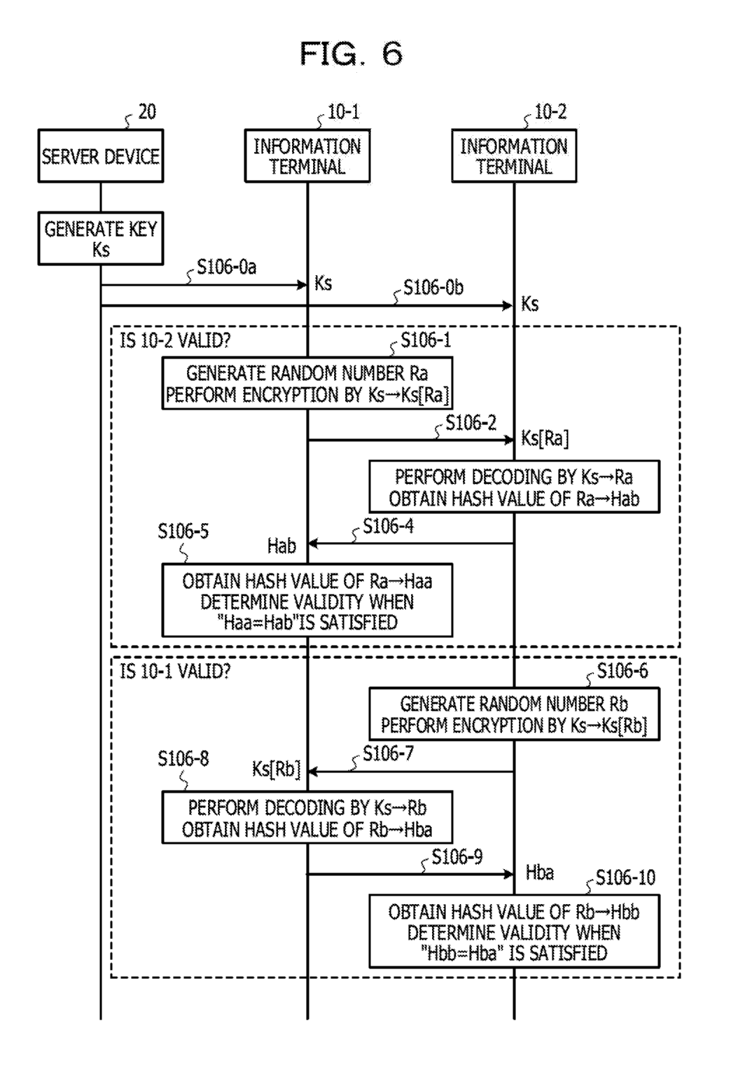

The proxy determination processing in Step S106 is described below with reference to FIG. 6. FIG. 6 is a sequence diagram illustrating an example of the proxy determination processing.

First, the control unit 25 of the server device 20 generates a key Ks and distributes the key Ks to the information terminals 10-1 and 10-2 (Steps S106-0a and 106-0b). For example, the key Ks may be downloaded to the app when the app is executed in the information terminal 10-1 in the Step S102 of FIG. 4. Alternatively, instead of the server device 20, the information terminal 10-1 may generate the key Ks and distribute the key Ks to the server device 20, the information terminals 10-2, and the like. In this case, for example, the information terminal 10-1 may register the key Ks in the server device 20 in advance, and distribute the key Ks to a reliable information terminal 10-2, and the like.

Next, the information terminal 10-1 executes authentication processing for the information terminal 10-2.

Specifically, in Step S106-1, the proxy determination unit 13 of the information terminal 10-1 generates a random number Ra, and calculates data that has been obtained by encrypting the random number Ra by using the key Ks. Hereinafter, the data is referred to as “Ks[Ra]”.

Next, the proxy determination unit 13 of the information terminal 10-1 notifies the information terminal 10-2 of the Ks[Ra] (Step S106-2).

When the proxy determination unit 13 of the information terminal 10-2 receives the Ks[Ra], the proxy determination unit 13 calculates the random number Ra by decoding the Ks[Ra] by using the key Ks that has been distributed from the server device 20, and calculates a hash value Hab of the Ra (Step S106-3).

Next, the proxy determination unit 13 of the information terminal 10-2 notifies the information terminal 10-1 of the hash value Hab (Step S106-4).

Next, the proxy determination unit 13 of the information terminal 10-1 calculates a hash value Haa of the random number Ra, compares the hash value Haa against the received hash value Hab, and determines that the information terminal 10-2 is a valid proxy request destination when the hash value Haa and the received hash value Hab match with each other (Step S106-5). When the hash value Haa and the hash value Hab do not match each other, the proxy determination unit 13 determines that the information terminal 10-2 is not a valid proxy request destination.

Processing is described below in which the information terminal 10-2 authenticates the information terminal 10-1. The processing in which the information terminal 10-2 authenticates the information terminal 10-1 is similar to the above-described processing in which the information terminal 10-1 authenticates the information terminal 10-2.

In Step S106-6, the proxy determination unit 13 of the information terminal 10-2 generates a random number Rb, and calculates Ks[Rb] that has been obtained by encrypting the random number Rb by using the key Ks.

Next, the proxy determination unit 13 of the information terminal 10-2 notifies the information terminal 10-1 of the calculated Ks[Rb] (Step S106-7).

Next, the proxy determination unit 13 of the information terminal 10-1 calculates the Rb by decoding the received Ks[Rb] by using the key Ks that has been distributed from the server device 20, and calculates a hash value Hba of the Rb (Step S106-8).

Next, the proxy determination unit 13 of the information terminal 10-1 notifies the information terminal 10-2 of the calculated Hba (Step S106-9).

Next, the proxy determination unit 13 of the information terminal 10-2 calculates a hash value Hbb of the Rb, and compares the calculated Hbb against the received Hba, and determines that the information terminal 10-1 is a valid proxy request source when the calculated Hbb and the received Hba match each other (Step S106-10).

<Authentication at the Time of the Proxy Execution>

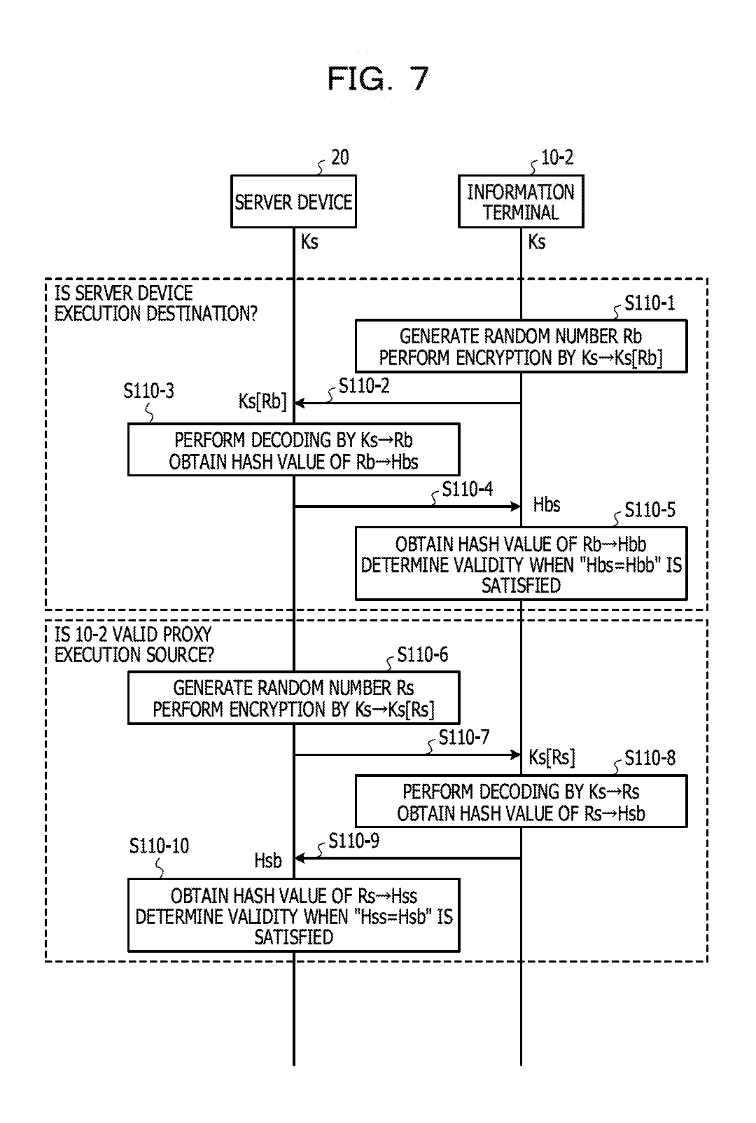

The authentication processing at the time of the proxy execution in Step S110 is described below with reference to FIG. 7. FIG. 7 is a sequence diagram illustrating an example of the authentication processing at the time of the proxy execution.

First, processing in which the proxy determination unit 13 of the information terminal 10-2 authenticates the server device 20 is described.

In Step S110-1, the proxy determination unit 13 of the information terminal 10-2 generates a random number Rb and calculates Ks[Rb] that has been obtained by encrypting the random number Rb by using the key Ks.

Next, the proxy determination unit 13 of the information terminal 10-2 notifies the server device 20 of the calculated Ks[Rb] (Step S110-2).

Next, the authentication unit 24 of the server device 20 calculates the Rb by decoding the received Ks[Rb] using the distributed key Ks and calculates a hash value Hbs of the Rb (Step S110-3).

Next, the authentication unit 24 of the server device 20 notifies the information terminal 10-2 of the calculated Hbs (Step S110-4).

Next, the proxy determination unit 13 of the information terminal 10-2 calculates a hash value Hbb of the Rb, compares the calculated Hbb with the received Hbs, and determines that the server device 20 is a valid proxy execution destination when the calculated Hbb and the received Hbs match with each other (Step S110-5).

Processing is described below in which the server device 20 authenticates the information terminal 10-2.

In Step S110-6, the authentication unit 24 of the server device 20 generates a random number Rs and calculates Ks[Rs] that has been obtained by encrypting the random number Rs by using the key Ks.

Next, the authentication unit 24 of the server device 20 notifies the information terminal 10-2 of the calculated Ks[Rs] (Step S110-7).

Next, the proxy determination unit 13 of the information terminal 10-2 calculates the Rs by decoding the received Ks[Rs] by using the key Ks and calculates a hash value Hsb of the Rs (Step S110-8).

Next, the proxy determination unit 13 of the information terminal 10-2 notifies the server device 20 of the calculated Hsb (Step S110-9).

Next, the authentication unit 24 of the server device 20 calculates a hash value Hss of the Rs, compares the calculated Hss with the received Hsb, and determines that the information terminal 10-2 is a valid proxy execution source when the calculated Hss and the received Hsb match with each other (Step S110-10).

<Authentication Failure>

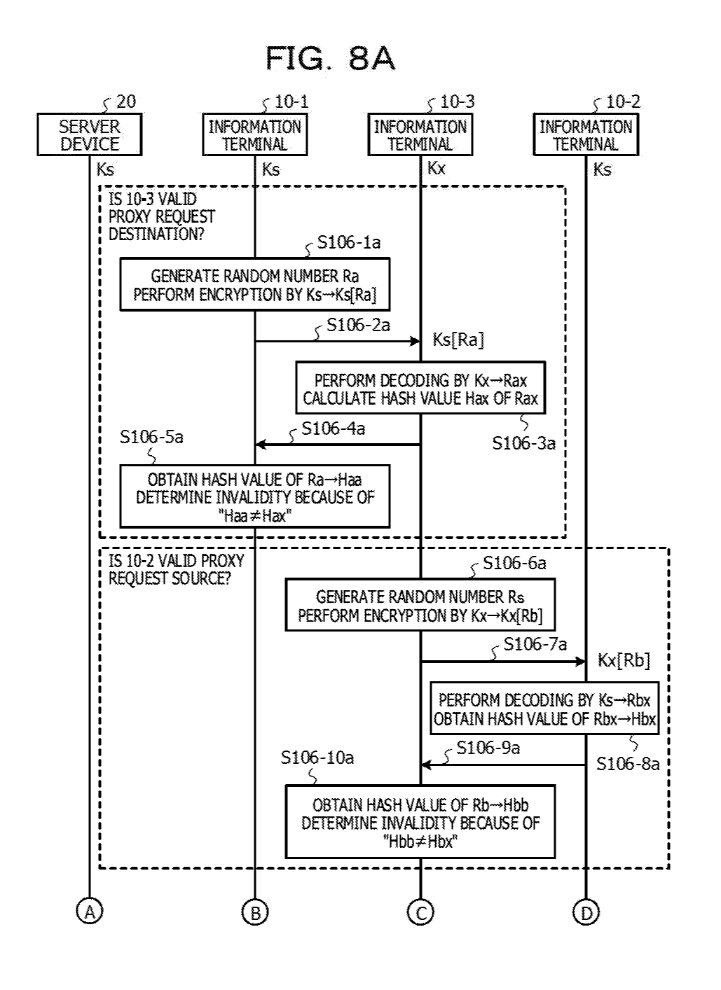

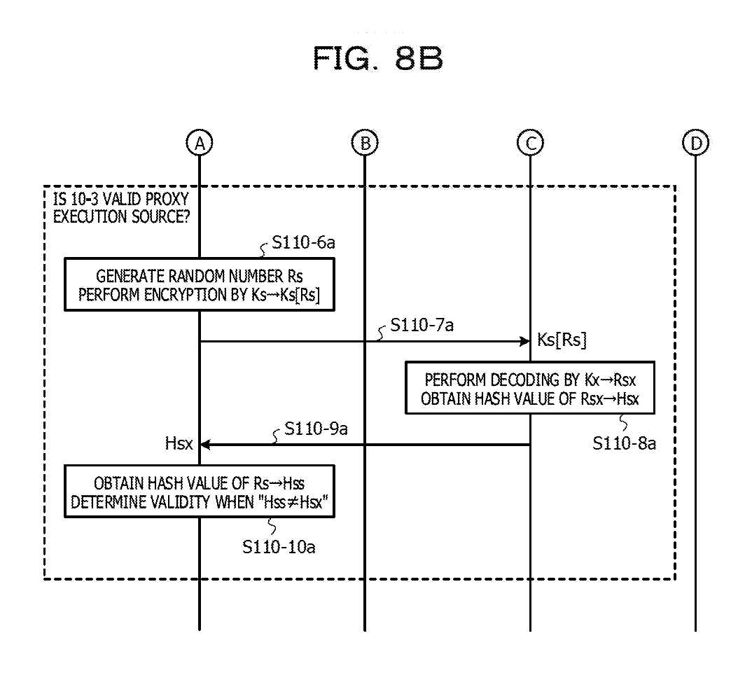

Processing in which authentication has not been performed successfully in the proxy determination processing in Step S106 and the authentication processing at the time of the proxy execution in Step S110 is described below with reference to FIG. 8. FIG. 8 is a sequence diagram illustrating an example of the processing in which authentication has not been performed successfully.

In the following description, it is assumed that an information terminal 10-3 is an unauthorized terminal to which the key Ks has not been distributed from the server device 20.

In Step S106-1a, the proxy determination unit 13 of the information terminal 10-1 generates a random number Ra and calculates Ks[Ra] that has been obtained by encrypting the random number Ra by using the key Ks.

Next, the proxy determination unit 13 of the information terminal 10-1 notifies the information terminal 10-3 of the calculated Ks[Ra] (Step S106-2a).

Next, the proxy determination unit 13 of the information terminal 10-3 calculates Rax by decoding the received Ks[Ra] using an unauthorized key Kx and calculates a hash value Hax of the Rax (Step S106-3a).

Next, the proxy determination unit 13 of the information terminal 10-3 notifies the information terminal 10-1 of the calculated Hax (Step S106-4a).

Next, the proxy determination unit 13 of the information terminal 10-1 calculates a hash value Haa of the Ra, compares the calculated Haa with the received Hax, and determines that the information terminal 10-3 is not a valid proxy request destination because the calculated Haa and the received Hax do not match each other (Step S106-5a).

Processing is described below in which the information terminal 10-3 authenticates the information terminal 10-2.

In Step S106-6a, the proxy determination unit 13 of the information terminal 10-3 generates a random number Rb and calculates Kx[Rb] that has been obtained by encrypting the random number Rb by using the illegal key Kx.

Next, the proxy determination unit 13 of the information terminal 10-3 notifies the information terminal 10-2 of the calculated Kx[Rb] (Step S106-7a).

Next, the proxy determination unit 13 of the information terminal 10-2 calculates Rbx by decoding the received Kx[Rb] by using the key Ks that has been distributed from the server device 20, and calculates a hash value Hbx of the Rbx (Step S106-8a).

Next, the proxy determination unit 13 of the information terminal 10-2 notifies the information terminal 10-3 of the calculated Hbx (Step S106-9a).

Next, the proxy determination unit 13 of the information terminal 10-3 calculates a hash value Hbb of the Rb, compares the calculated Hbb with the received Hbx, and determines that the information terminal 10-2 is not a valid proxy request source because the calculated Hbb and the received Hbx do not match each other (Step S106-10a).

Processing is described below in which the server device 20 authenticates the information terminal 10-3.

In Step S110-6a, the authentication unit 24 of the server device 20 generates a random number Rs and calculates Ks[Rs] that has been obtained by encrypting the random number Rs by using the key Ks.

Next, the authentication unit 24 of the server device 20 notifies the information terminal 10-3 of the calculated Ks[Rs] (Step S110-7a).

Next, the proxy determination unit 13 of the information terminal 10-3 calculates Rsx by decoding the received Ks[Rs] by using the key Kx and calculates a hash value Hsx of the Rsx (Step S110-8a).

Next, the proxy determination unit 13 of the information terminal 10-3 notifies the server device 20 of the calculated Hsx (Step S110-9a).

Next, the authentication unit 24 of the server device 20 calculates a hash value Hss of the Rs, compares the calculated Hss with the received Hsx, and determines that the information terminal 10-3 is not a valid proxy execution source because the calculated Hss and the received Hsx do not match each other (Step S110-10a).

As a result, information leakage from the information terminal and an unauthorized access to the server device 20 may be avoided.

<Encryption of App Information>

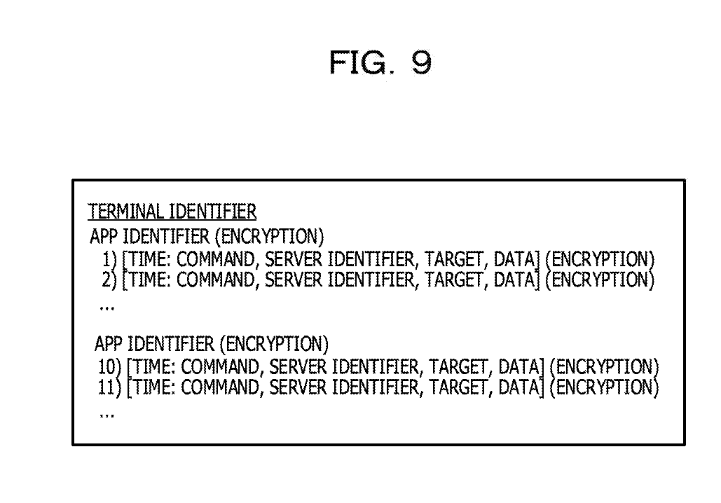

A case in which the app information 121 is encrypted and transmission and reception of the app information 121 are performed is described below with reference to FIGS. 4 and 9.

After the server device 20 has been disconnected from the information terminal 10-1 in Step S103, the control unit 25 of the server device 20 associates a session key with a terminal identifier of the information terminal 10-1 and stores the session key together with the terminal identifier. Here, the session key is data by which an HTTP session between the information terminal 10-1 and the server device 20 is allowed to be identified when the app is a web app, and for example, is a disposable encryption key that is valid only from the start to the end of communication. In addition, as the session key, a session ID or Cookie issued to the information terminal 10-1 from the server device 20 may be used.

The communication unit 14 of the information terminal 10-1 transmits the encrypted app information 121 to the information terminal 10-2 in Step S107.

FIG. 9 is a diagram illustrating the encrypted app information. In the example of FIG. 9, items other than a terminal identifier are encrypted. In the example of FIG. 9, each piece of data (processing request of the app) with which items of a time, a command, a server identifier, a target, data, and the like, are associated is encrypted, and a serial number indicating a chronological sequence is assigned to the data. As a key for the encryption, for example, the session key used when the information terminal 10-1 has been coupled to the server device 20 in Step S102 may be used.

The proxy unit 15 of the information terminal 10-2 is coupled to the server device 20 in Step S109, notifies the server device 20 of the terminal identifier included in the app information in Step S110, and transmits the pieces of data included in the app information in the sequence of the serial numbers.

The control unit 25 of the server device 20 decodes the app information using the session key that has associated with the received terminal identifier, and causes the service unit 21 to execute each command in Step S111.

As a result, it may be avoided that the app processing request in the information terminal 10-1 is known to devices other than the server device 20.

<Proxy Request for Plurality of Information Terminals>

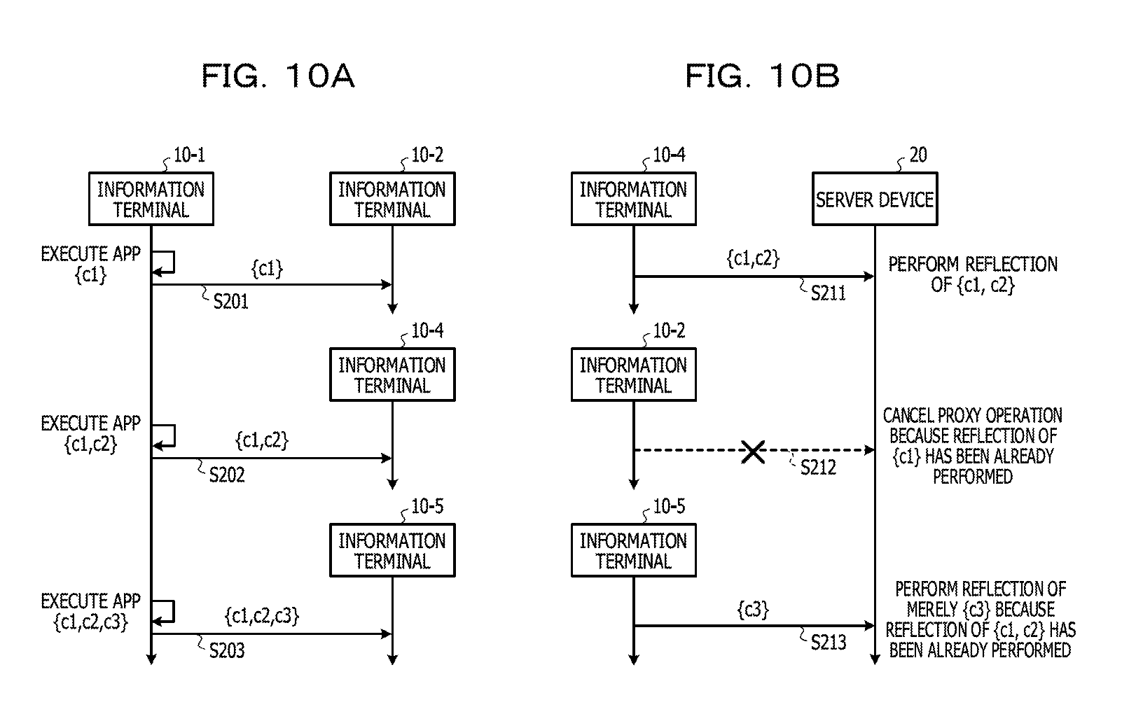

A case in which the information terminal 10-1 requests a proxy operation for a plurality of information terminals 10-2, 10-4, and 10-5 is described below with reference to FIGS. 10A and 10B.

FIGS. 10A and 10B are diagrams each illustrating a case in which the proxy operation is requested for the plurality of information terminals.

As illustrated in FIG. 10A, it is assumed that, the information terminal 10-1 requests a proxy operation for the information terminals 10-2, 10-4, and 10-5 in that order while the information terminal 10-1 executes the app in the offline state. In this case, the information terminals 10-2, 10-4, and 10-5 respectively receive pieces of app information [c1], [c1,c2], and [c1,c2,c3] of the information terminal 10-1 at the respective time points at which a proxy operation has been requested for the information terminals 10-2, 10-4, and 10-5 (Steps S201, S202, and S203). Here, “c1”, “c2”, and “c3” correspond to processing requests (commands) for the server.

Next, when the information terminals 10-2, 10-4, and 10-5 are respectively coupled to the server device 20 at different timings, the information terminals 10-2, 10-4, and 10-5 executes the proxy operation of the information terminal 10-1.

As illustrated in FIG. 10B, it is assumed that the information terminals 10-4, 10-2, and 10-5 are coupled to the server device 20 in that order.

In this case, the information terminal 10-4 transmits the app information [c1,c2] of the information terminal 10-1 at the time at which the proxy operation has been requested, to the server device 20, and performs reflection of the app information [c1,c2] of the information terminal 10-1 for the server device 20 (Step S211).

The proxy unit 15 of the information terminal 10-2 does not execute the proxy operation because reflection of the app information [c1] of the information terminal 10-1 at the time at which the proxy operation had been requested has been already performed for the server device 20 (Step S212). Processing in which whether reflection of the app information [c1] has been already performed for the server device 20 is determined is described later.

Because the [c1,c2] in the app information [c1,c2,c3] of the information terminal 10-1 at the time at which reflection of the proxy operation had been requested has been already performed for the server device 20, the information terminal 10-5 transmits merely the [c3] to the server device 20, and performs reflection of the app information [c3] of the information terminal 10-1 for the server device 20 (Step S213). Processing is described below in which whether reflection of the app information [c1,c2] has been already performed for the server device 20 is determined.

<Processing of the Information Terminal>

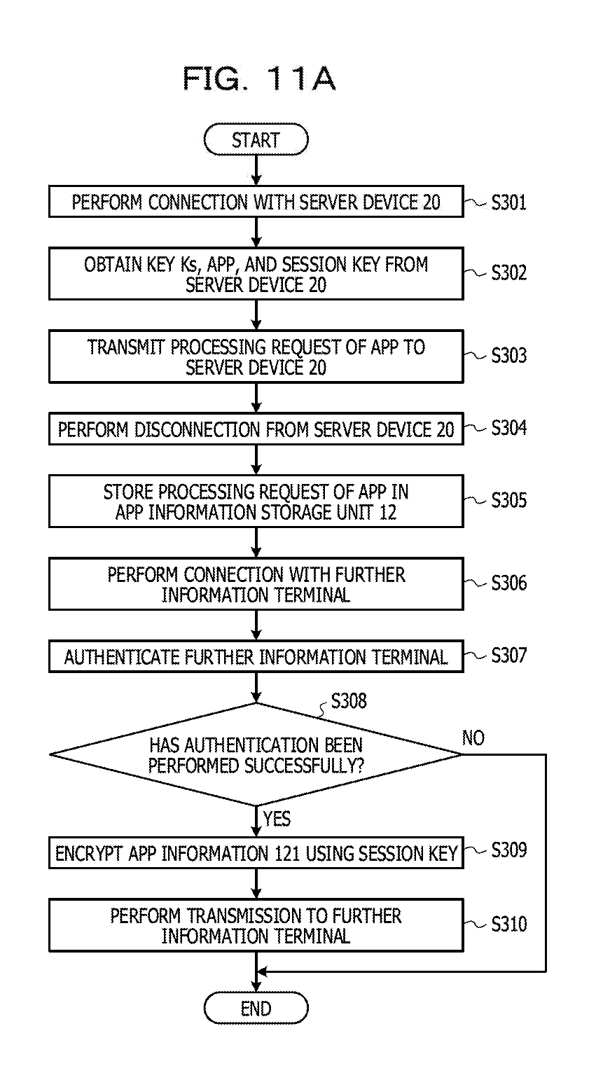

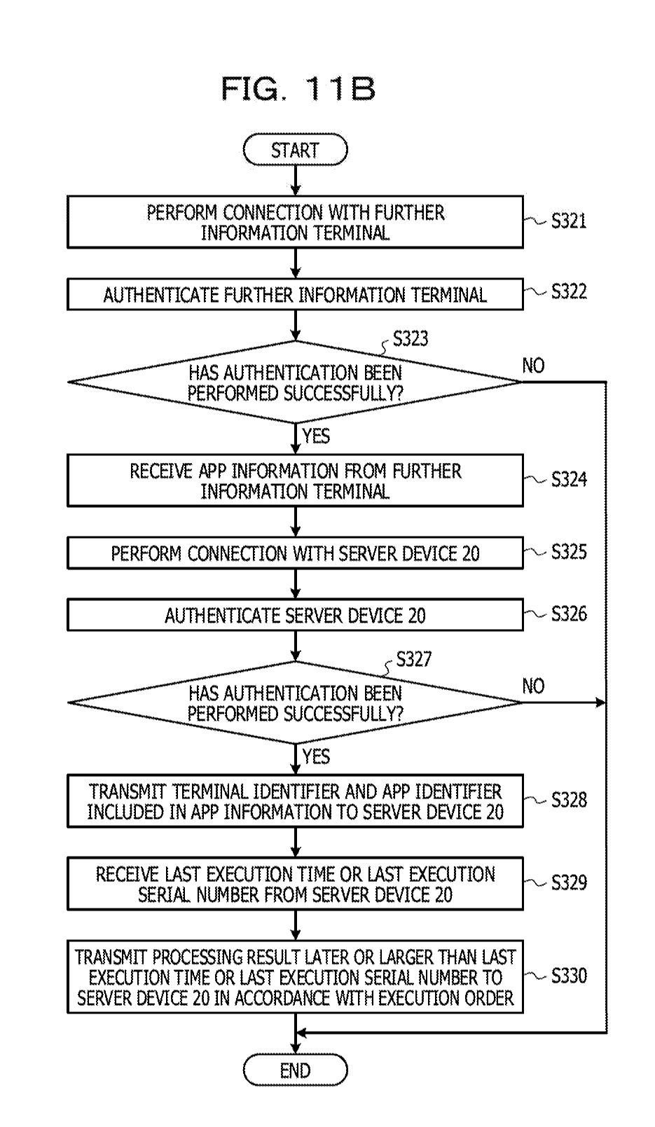

Processing executed by an information terminal 10 is described below with reference to FIGS. 11A and 11B.

<Proxy Request>

FIG. 11A is a flowchart illustrating an example of processing executed by an information terminal 10 that is a proxy request source.

In Step S301, the communication unit 14 is coupled to the server device 20.

Next, the app execution unit 11 obtains a key Ks, an app, a session key from the server device 20 (Step S302).

Next, the app execution unit 11 executes the app based on an operation or the like by the user and transmits a processing request to the server device 20 through the communication unit 14 (Step S303).

Next, the communication unit 14 is disconnected from the server device 20 (Step S304).

Next, the app execution unit 11 executes the app based on the operation or the like by the user and stores the app information 121 in the app information storage unit 12 (Step S305).

Next, the communication unit 14 is coupled to a further information terminal 10 (Step S306).

Next, the proxy determination unit 13 authenticates the further information terminal 10 (Step S307).

Next, the proxy determination unit 13 determines whether the authentication of the further information terminal 10 has been performed successfully (Step S308), and ends the processing when the authentication has not been performed successfully (NO in Step S308).

When the authentication has been performed successfully (YES in Step S308), the communication unit 14 encrypts the app information 121 stored in the app information storage unit 12 using the session key that has been received in Step S302 (Step S309) and transmits the encrypted app information 121 to the further information terminal 10 (Step S310). As a result, the proxy request is completed. The information terminal 10 may display information indicating that the app information is to be transmitted to the further information terminal 10 on the screen before transmitting the app information 121 to the further information terminal 10, and execute the processing in Step S309 when the information terminal 10 has received a confirmation operation from the user.

<Proxy Execution>

FIG. 11B is a flowchart illustrating an example of processing executed by an information terminal 10 that is a proxy request destination.

In Step S321, the communication unit 14 is coupled to a further information terminal 10 (Step S321).

Next, the proxy determination unit 13 authenticates the further information terminal 10 (Step S322).

Next, the proxy determination unit 13 determines whether the authentication of the further information terminal 10 has been performed successfully (Step S323), and ends the processing when the authentication has not been performed successfully (NO in Step S323).

When the authentication has been performed successfully (YES in Step S323), the communication unit 14 receives app information from the further information terminal 10 (Step S324).

After that, at a specific timing, the communication unit 14 is coupled to the server device 20 (Step S325).

Next, the proxy determination unit 13 authenticates the server device 20 (Step S326).

Next, the proxy determination unit 13 determines whether the authentication of the server device 20 has been performed successfully (Step S327), and ends the processing when the authentication has not been performed successfully (NO in Step S327).

When the authentication has been performed successfully (YES in Step S327), the proxy unit 15 transmits a terminal identifier and an app identifier included in the app information 121 that has been received in Step S324, to the server device 20 through the communication unit 14 (Step S328).

Next, the communication unit 14 receives the last execution time or the last execution serial number from the server device 20 (Step S329).

Next, the proxy unit 15 transmits, to the server device 20, a command or the like (processing request) the time or the serial number which is later or larger than the last execution time or the last execution serial number that has been received in Step S329, in the app information 121 that have been received in Step S324, in accordance with the execution order (sequence according to time or sequence of the serial numbers) (Step S330), and ends the processing.

<Processing of the Server Device>

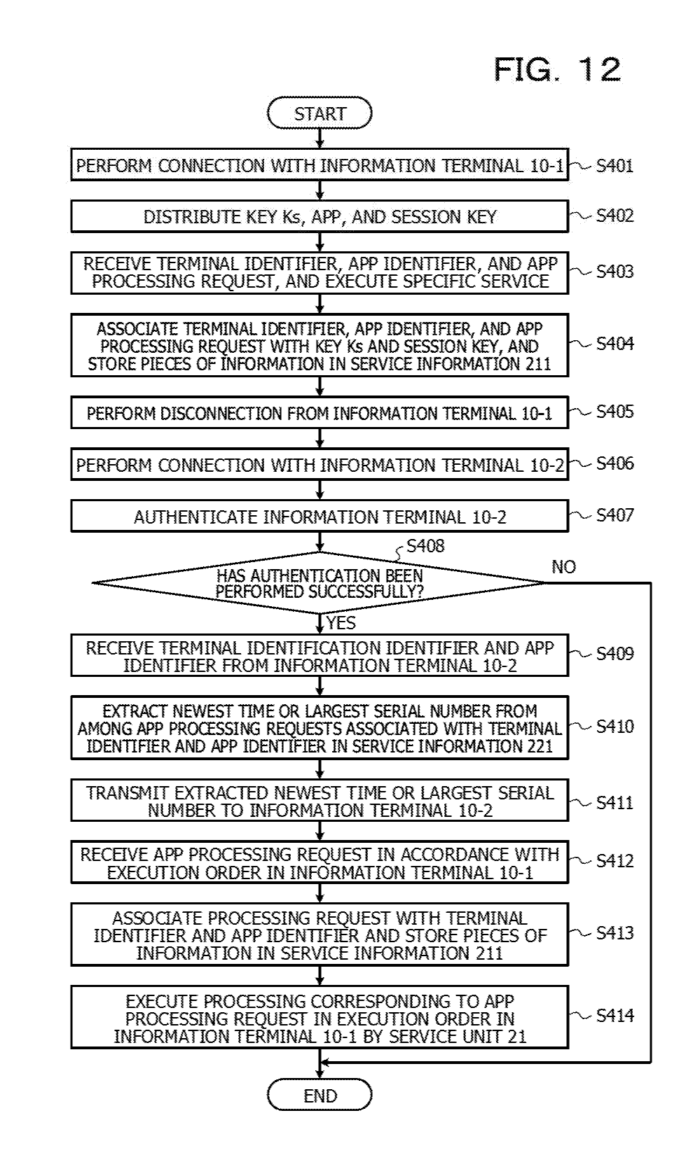

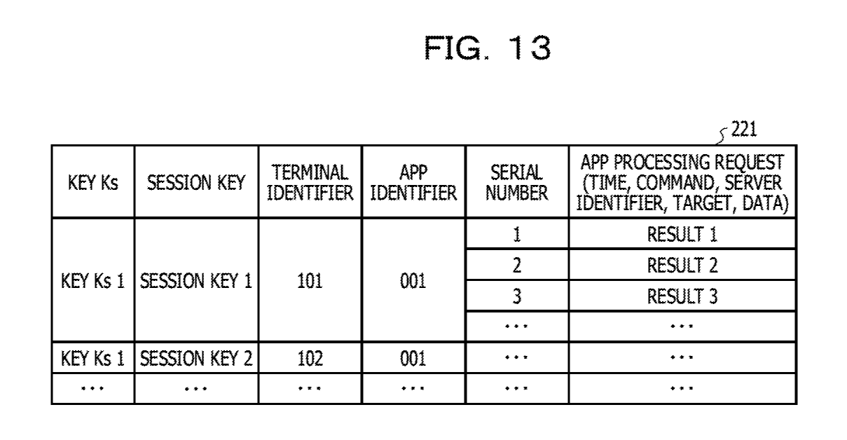

Processing executed by the server device 20 is described below with reference to FIGS. 12 and 13. FIG. 12 is a flowchart illustrating an example of the processing executed by the server device 20.

In Step S401, the communication unit 23 is coupled to the information terminal 10-1.

Next, the service unit 21 distributes a key Ks, an app, and a session key to the information terminal 10-1 (Step S402).

Next, the service unit 21 receives app information 121 from the information terminal 10-1, and executes processing corresponding to each processing request (command, data, and the like) included in the app information 121 (Step S403).

Next, the control unit 25 associates a terminal identifier, an app identifier, an app processing request, and the like included in the received app information, with the session key and the key Ks that have been distributed in Step S402, and stores the pieces of information in the service information storage unit 22 as service information 221 (Step S404). FIG. 13 is a diagram illustrating an example of the service information 221.

Next, the communication unit 23 is disconnected from the information terminal 10-1 (Step S405).

After that, when the communication unit 23 receives a connection request from the information terminal 10-2 for which a proxy operation has been requested, the communication unit 23 is coupled to the information terminal 10-2 (Step S406).

Next, the authentication unit 24 authenticates the information terminal 10-2 (Step S407).

Next, the authentication unit 24 determines whether the authentication of the information terminal 10-2 has been performed successfully (Step S408), and ends the processing when the authentication has not been performed successfully (NO in Step S408).

When the authentication has been performed successfully (YES in Step S408), the control unit 25 receives a terminal identifier and an app identifier from the information terminal 10-2 (Step S409).

Next, the control unit 25 extracts the newest time or the largest serial number from among app processing requests that have been associated with the terminal identifier and the app identifier in the service information 221 (Step S410).

Next, the control unit 25 transmits the extracted newest time or largest serial number to the information terminal 10-2 (Step S411).

Next, the control unit 25 receives the app processing request from the information terminal 10-1 in accordance with the execution order in the information terminal 10-1 (Step S412), associates the processing request with the terminal identifier and the app identifier that have been received in Step S409, and stores the pieces of information in service information 211 (Step S413).

Next, the control unit 25 causes the service unit 21 to execute the app processing request, in the execution order in the information terminal 10-1 (Step S414). As a result, the processing request during the offline state in the information terminal 10-1 is executed by the service unit 21.

<Modification>

The information terminal 10 may request a proxy operation that has been requested from a further information terminal, for a following information terminal. In this case, the information terminal 10 records app information related to the proxy request that has been received from the further information terminal in the app information 121. In addition, the information terminal 10 transmits the app information related to the proxy request that has been received from the further information terminal to the following information terminal so that the app information is included in the app information 121. As a result, a probability in which the proxy operation is executed may be improved.

### Second Embodiment

In a second embodiment, a case is described in which a device separate from a server device 20 authenticates an information terminal 10 and relays communication between the authenticated information terminal 10 and the server device 20. The second embodiment is similar to the first embodiment except for some points, so that the description is omitted as appropriate.

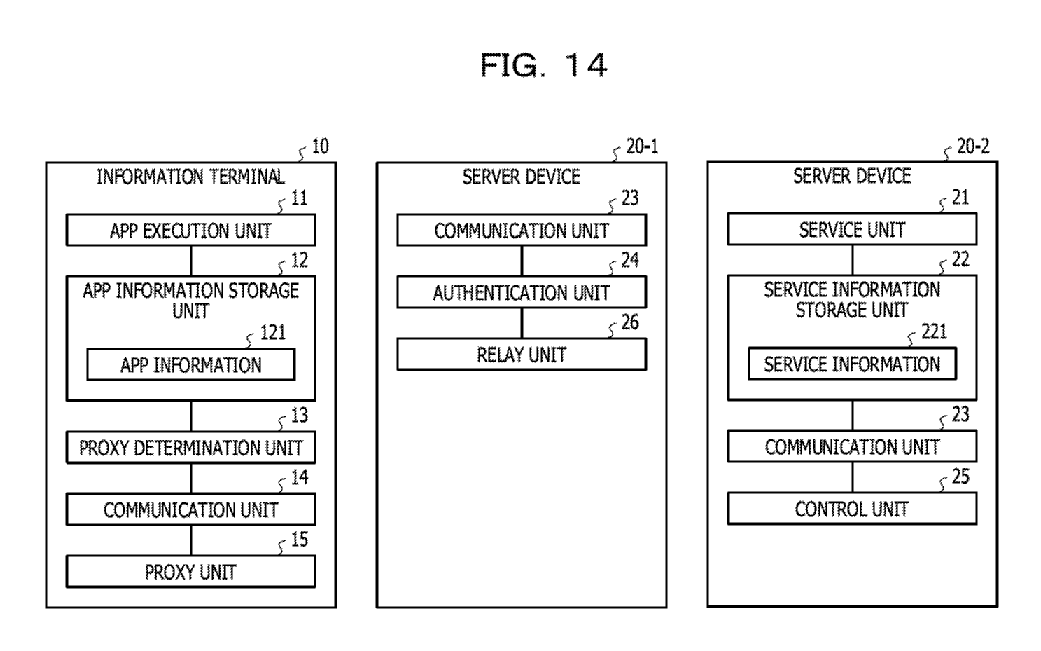

FIG. 14 is a diagram illustrating a configuration example of an information processing system according to the second embodiment. As illustrated in FIG. 14, a server device 20-1 includes an authentication unit 24 and a relay unit 26 that relays communication between the information terminal 10 and a server device 20-2. The authentication unit 24 of the server device 20-1 obtains and stores a key Ks and the like that have been generated in the server device 20-2. Therefore, the authentication of the information terminal 10 is allowed to be performed.

The relay unit 26 stores a list of transfer destination server devices, and determines a server device that is a transfer destination of app information that has been received from the information terminal 10, based on a server identifier included in the app information. In addition, the relay unit 26 relays the communication between the information terminal 10 and the determined server device 20-2.

As a result, even in a case in which the information terminal 10 exists at a location or the like in which the information terminal 10 is not allowed to be coupled to the server device 20-2, as long as the information terminal 10 is coupled to the server device 20-1, reflection of a processing request of the app may be performed.

### Third Embodiment

In a third embodiment, an example is described in which a server device 20 deletes app information the reflection of which has been already performed for a service unit 21 by the proxy operation, from an app information storage unit 12 of an information terminal 10. The third embodiment is similar to the first or second embodiment except for some points, so that the description is omitted as appropriate.

<Processing>

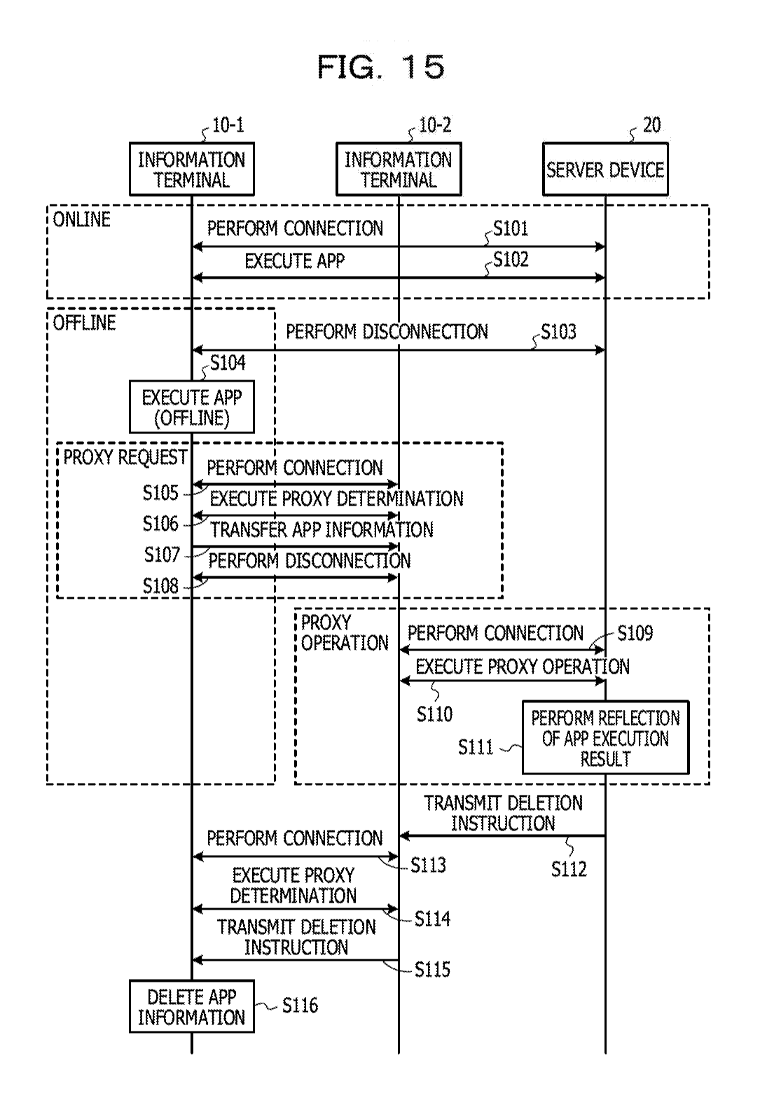

Processing of an information processing system 1 according to the third embodiment is described below with reference to FIG. 15. FIG. 15 is a sequence diagram illustrating an example of the processing of the information processing system 1 according to the third embodiment.

Processing in Steps S101 to S111 is similar to that of the information processing system 1 according to the first embodiment illustrated in FIG. 4.

In Step S112, a control unit 25 according to the third embodiment transmits a deletion instruction to an information terminal 10-2. In the deletion instruction, the newest time or the largest serial number is included from among app processing requests of the reflections of which have been performed for a service unit 21. The deletion instruction includes, for example, items of a terminal identifier, an app identifier, a server identifier, and a time.

After the proxy execution, due to movement of the information terminal 10-2 to the communication range of an information terminal 10-1 again, a proxy unit 15 of the information terminal 10-2 is coupled to the information terminal 10-1 (Step S113), performs authentication by proxy determination (Step S114), and transmits the deletion instruction to the information terminal 10-1 (Step S115).

The proxy unit 15 of the information terminal 10-1 deletes the app information the reflection of which has been already performed for the server device 20 from the app information storage unit 12 in accordance with the deletion instruction (Step S116).

As a result, unnecessary app information is deleted, so that the storage capacity of the app information storage unit 12 may be effectively utilized. The information terminal 10-1 may delete app information that has been executed before a time period that has been set in advance, in the app information 121 stored in the app information storage unit 12.

### Fourth Embodiment

In a fourth embodiment, an example is described in which an information terminal 10 requests a proxy operation of distribution of an app and the like from a server device 20. The fourth embodiment is similar to the first, second, or third embodiment except for some points, so that the description is omitted as appropriate.

<Processing>

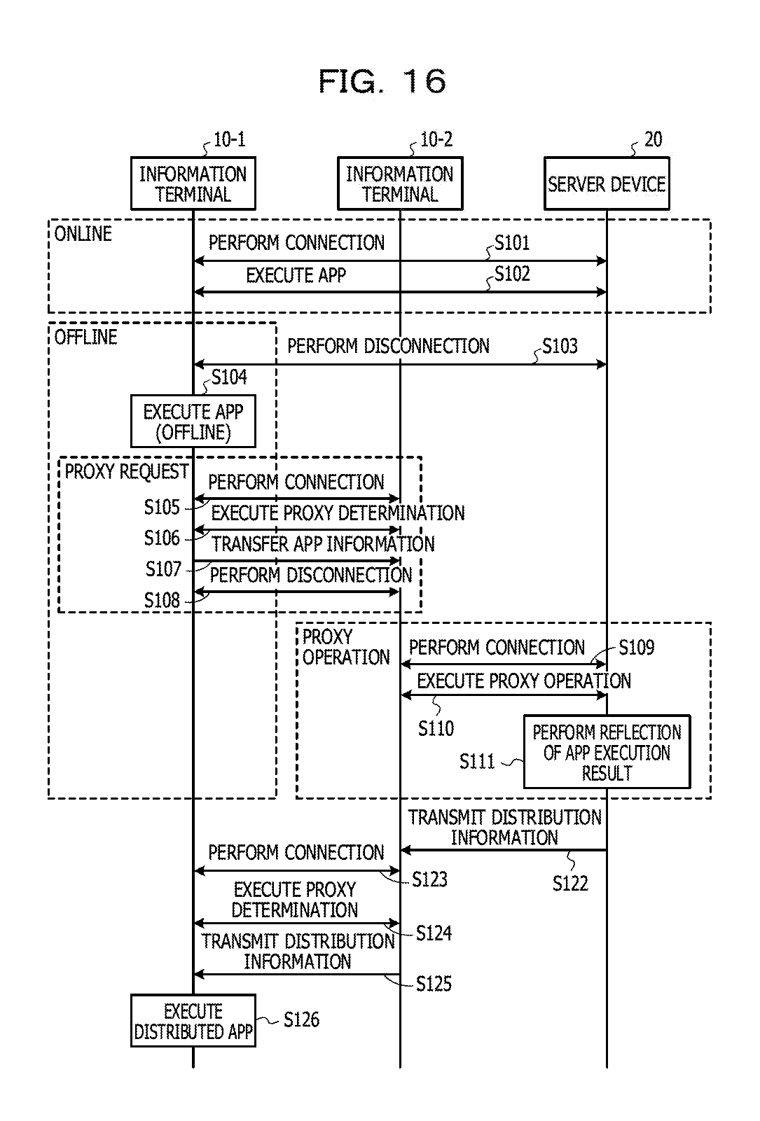

Processing of an information processing system 1 according to the fourth embodiment is described below with reference to FIG. 16. FIG. 16 is a sequence diagram illustrating an example of the processing of the information processing system 1 according to a fourth embodiment.

Processing in Steps S101 to S111 is similar to that of the information processing system 1 according to the first embodiment illustrated in FIG. 4.

In Step S122, a control unit 25 according to the fourth embodiment transmits, to the information terminal 10-2, distribution information including an app corresponding to a processing request the reflection of which has been performed for a service unit 21 and a terminal identifier of a distribution destination.

After the proxy execution, due to movement of the information terminal 10-2 to the communication range of an information terminal 10-1 again, a proxy unit 15 of the information terminal 10-2 is coupled to the information terminal 10-1 (Step S123), and performs authentication by proxy determination (Step S124), and transmits the distribution information to the information terminal 10-1 (Step S125).

The proxy unit 15 of the information terminal 10-1 causes the app execution unit 11 to execute the app included in the distribution information (Step S126). As a result, the app corresponding to the processing request the reflection of which has been performed for the service unit 21 is distributed to the information terminal 10-1 that is not coupled to the server device 20.

The embodiments of the technology discussed herein is as described above, but the technology discussed herein is not limited to such embodiments, and various modifications and changes may be made within the scope of the gist of the technology discussed herein, which is described in the claims.

Each of the function units of the information terminal 10 is realized, for example, by cloud computing constituted by one or more computers.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to
execute first transmission processing that includes transmitting a processing request that corresponds to an operation of a user to a server device coupled to the information processing device through a network, in accordance with the operation by the user,
execute storage processing that includes storing a processing request that corresponds to an operation executed when communication with the server device is not allowed to be performed, and
execute second transmission processing that includes transmitting the processing request stored during the storage processing, to a further information processing device allowed to transmit a processing request that corresponds to an operation by the user to the server device.

2. The information processing device according to claim 1, wherein
the second transmission processing includes performing transmission of a plurality of processing requests stored during the storage processing using a short-range wireless communication.

3. The information processing device according to claim 2, wherein
the storage processing includes storing information indicating an order of a plurality of operations executed when the communication with the server device is not allowed to be performed, and processing requests that respectively correspond to the plurality of operations, and
the second transmission processing includes performing transmission of the information indicating the order of the plurality of operations and the processing requests that respectively correspond to the plurality of operations stored during the storage processing.

4. The information processing device according to claim 3, wherein
the processor is further configured to
execute authentication processing that includes obtaining a key from the server device and authenticating the further information processing device, based on whether the further information processing device includes a key identical to the obtained key.

5. The information processing device according to claim 4, wherein
the second transmission processing includes encrypting the plurality of processing requests stored during the storage processing, using identification information of communication executed when the transmission of the processing request is performed during the first transmission processing, which is shared between the information processing device and the server device, and transmitting an issuance order of the encrypted plurality of processing requests and the processing requests to the further information processing device.

6. The information processing device according to claim 1, wherein
the processor is further configured to
execute reception processing that includes receiving the processing request from a further information processing device that executes the second transmission processing, and
execute proxy processing that includes transmitting the received processing request to the server device.

7. The information processing device according to claim 6, wherein
the reception processing includes receiving information indicating an order of a plurality of operations and processing requests that respectively correspond to the plurality of operations, and
the proxy processing includes transmitting the processing requests that respectively correspond to the plurality of operations to the server device, in the order of the plurality of operations.

8. The information processing device according to claim 6, wherein
the proxy processing includes transmitting a processing request that is yet to be received by the server device, to the server device, from among the plurality of processing requests received during the reception processing when information indicating a processing request that is already received by the server device is received from the server device.

9. An information processing system comprising:
a first information processing device;
a second information processing device; and
a server device, wherein
the first information processing device includes
a memory; and
a processor coupled to the memory and configured to
execute first transmission processing that includes transmitting a processing request that corresponds to an operation of a user to a server device coupled to the first information processing device through a network, in accordance with the operation by the user,
execute storage processing that includes storing a processing request that corresponds to an operation executed when communication performed with the server device is not allowed to be performed, and
execute second transmission processing that includes transmitting the processing request stored in a storage unit, to a further information processing device allowed to transmit a processing request that corresponds to an operation by the user to the server device, and
the second information processing device includes
a memory; and
a processor coupled to the memory and configured to
execute reception processing that includes receiving the processing request transmitted from the first information processing device, and
execute proxy processing that includes transmitting the received processing request to the server device.

10. The information processing system according to claim 9, wherein
the second transmission processing includes performing transmission of a plurality of processing requests stored in the storage unit using short-range wireless communication.

11. The information processing system according to claim 10, wherein
the storage processing includes storing information indicating an order of a plurality of operations executed when the communication with the server device is not allowed to be performed and processing requests that respectively correspond to the plurality of operations, and
the second transmission processing includes performing transmission of the information indicating the order of the plurality of operations and the processing requests that respectively correspond to the plurality of operations stored during the storage processing.

12. The information processing system according to claim 11, wherein
the processor of the first information processing device is further configured to
execute authentication processing that includes obtaining a key from the server device and authenticating the further information processing device, based on whether the further information processing device includes a key identical to the obtained key.

13. The information processing system according to claim 12, wherein
the second transmission processing includes encrypting the plurality of processing requests stored in the storage unit, using identification information of communication executed when a first transmission unit performs the transmission of the processing request, which is shared between the first transmission unit and the server device, and transmitting an issuance order of the encrypted plurality of processing requests and the processing requests to the further information processing device.

14. The information processing system according to claim 13, wherein
the reception processing includes receiving information indicating an order of a plurality of operations and processing requests that respectively correspond to the plurality of operations, and
the proxy processing includes transmitting the processing requests that respectively correspond to the plurality of operations to the server device, in the order of the plurality of operations.

15. The information processing system according to claim 14, wherein
the proxy processing includes transmitting a processing request that is yet to be received by the server device, to the server device, from among the plurality of processing requests received during the reception processing when information indicating a processing request that is already received by the server device is received from the server device.

16. A non-transitory computer-readable storage medium storing a program that causes a computer to execute a process, the process comprising:
executing first transmission processing that includes transmitting a processing request that corresponds to an operation of a user to a server device coupled to the information processing device through a network, in accordance with the operation by the user,
executing storage processing that includes storing a processing request that corresponds to an operation executed when communication with the server device is not allowed to be performed, and
executing second transmission processing that includes transmitting the processing request stored during the storage processing, to a further information processing device allowed to transmit a processing request that corresponds to an operation by the user to the server device.

17. The non-transitory computer-readable storage medium according to claim 16, wherein
the second transmission processing includes performing transmission of a plurality of processing requests stored during the storage processing using a short-range wireless communication.

18. The non-transitory computer-readable storage medium according to claim 17, wherein
the storage processing includes storing information indicating an order of a plurality of operations executed when the communication with the server device is not allowed to be performed, and processing requests that respectively correspond to the plurality of operations, and
the second transmission processing includes performing transmission of the information indicating the order of the plurality of operations and the processing requests that respectively correspond to the plurality of operations stored during the storage processing.

19. The non-transitory computer-readable storage medium according to claim 18, the process further comprising:
executing authentication processing that includes obtaining a key from the server device and authenticating the further information processing device, based on whether the further information processing device includes a key identical to the obtained key.

20. A information processing method, performed by a computer, the method comprising:
executing, performed by a processor of the computer, first transmission processing that includes transmitting a processing request that corresponds to an operation of a user to a server device coupled to the information processing device through a network, in accordance with the operation by the user,
executing, performed by the processor of the computer, storage processing that includes storing a processing request that corresponds to an operation executed when communication with the server device is not allowed to be performed, and
executing, performed by the processor of the computer, second transmission processing that includes transmitting the processing request stored during the storage processing, to a further information processing device allowed to transmit a processing request that corresponds to an operation by the user to the server device.
